(19) United States
(12) Patent Application Publication
(10) Pub. No.: US 2026/0051806 A1
(43) Pub. Date: Feb. 19, 2026

(54) SYNCHRONOUS RECTIFIER CONTROL CIRCUITS AND METHODS OF OPERATING THE SAME

(71) Applicant: Navitas Semiconductor Limited, Dublin (IE)

(72) Inventors: Changhu YU, Shenzhen (CN); Zhuang LIN, Shanghai (CN); Chien-Chun HUANG, Taoyuan City (TW); Wei-Ting WANG, Hsinchu (TW); Kai-Fang WEI, San Jose, CA (US)

(73) Assignee: Navitas Semiconductor Limited, Dublin (IE)

(21) Appl. No.: 19/298,970

(22) Filed: Aug. 13, 2025

(30) Foreign Application Priority Data
Aug. 15, 2024 (CN) 202411122672X

(51) Int. Cl. H02M 1/088; H02M 1/00; H02M 3/335

(52) U.S. Cl. CPC H02M 1/088; H02M 1/0012; H02M 3/33571; H02M 3/33592

(57) ABSTRACT

A circuit. The circuit includes a transformer having a primary winding magnetically coupled to a secondary winding, the primary winding including a first terminal connected to an input voltage and a second terminal coupled to a ground via a primary switch, where the secondary winding includes a third terminal connected to an output terminal, and further includes a fourth terminal connected to a secondary switch, where the secondary switch includes a gate terminal, a source terminal and a drain terminal, and a comparator having a first input connected to a predetermined voltage, a second input connected to the drain terminal, and an output coupled to a half-bridge circuit. In one aspect, the comparator and the half-bridge circuit are arranged to receive a voltage signal from the drain terminal and generate a corresponding gate voltage signal at the gate terminal to control a conductivity state of the secondary switch.

### CROSS REFERENCE TO RELATED APPLICATIONS

This application claims priority to Chinese provisional patent application no. 202411122672X, for “SYNCHRONOUS RECTIFIER REGULATION CIRCUITS AND METHODS OF OPERATING THE SAME” filed on Aug. 15, 2024, which is hereby incorporated by reference in entirety for all purposes.

### FIELD

The described embodiments relate generally to power converters, and more particularly, the present embodiments relate to secondary side synchronous rectifier control circuits and methods of operating the control circuits.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices.

### SUMMARY

In some embodiments, a circuit is disclosed. The circuit includes a transformer including a primary winding magnetically coupled to a secondary winding, the primary winding including a first terminal connected to an input voltage and a second terminal coupled to a ground via a primary switch, where the secondary winding includes a third terminal connected to an output terminal, and further includes a fourth terminal connected to a secondary switch, where the secondary switch includes a gate terminal, a source terminal and a drain terminal; an amplifier having a first input coupled to a first predetermined voltage, a second input coupled to the drain terminal, and a first output connected to the gate terminal; and a first comparator having a third input connected to the first predetermined voltage, a fourth input connected to the drain terminal, and a second output coupled to the gate terminal; and a second comparator having a fifth input connected to a second predetermined voltage, a sixth input connected to the drain terminal, and a third output connected to the gate terminal; and where the amplifier and the first and second comparators are arranged to receive a voltage signal from the drain terminal and generate a corresponding gate voltage signal at the gate terminal to control a conductivity state of the secondary switch.

In some embodiments, the first output is connected to the gate terminal through a pull-down switch that is connected to the gate terminal.

In some embodiments, the second output is connected to the gate terminal through a set-reset latch that is connected to the pull-down switch.

In some embodiments, the third output is connected to the gate terminal through the set-reset latch.

In some embodiments, the first predetermined voltage has a value that is different than the second predetermined voltage.

In some embodiments, when a drain terminal voltage goes below the second predetermined voltage, the amplifier and the first and second comparators are arranged to regulate the drain terminal voltage such that it remains between the first and second predetermined voltages.

In some embodiments, when a drain terminal voltage goes below the second predetermined voltage, the gate voltage signal at the gate terminal is increased at a first rate of voltage with respect to time from a first voltage to a first intermediate voltage, and at a second rate of voltage with respect to time from the first intermediate voltage to a second voltage.

In some embodiments, the first voltage is zero.

In some embodiments, the circuit further includes a third comparator having a seventh input connected to a third predetermined voltage, an eight input connected to the drain terminal, and a fourth output connected to the gate terminal.

In some embodiments, the third predetermined voltage is smaller than the first predetermined voltage, where the third comparator is arranged to turn off the secondary switch when a drain terminal voltage drops below the third predetermined voltage.

In some embodiments, a transformer including a primary winding magnetically coupled to a secondary winding, the primary winding including a first terminal connected to an input voltage and a second terminal coupled to a ground via a primary switch, where the secondary winding includes a third terminal connected to an output terminal, and further includes a fourth terminal connected to a secondary switch, where the secondary switch includes a gate terminal, a source terminal and a drain terminal; and a comparator having a first input connected to a predetermined voltage, a second input connected to the drain terminal, and an output coupled to a half-bridge circuit; where the comparator and the half-bridge circuit are arranged to receive a voltage signal from the drain terminal and generate a corresponding gate voltage signal at the gate terminal to control a conductivity state of the secondary switch.

In some embodiments, the output is coupled to the half-bridge circuit via an RS flip-flop.

In some embodiments, the half-bridge circuit includes a first N-channel metal oxide semiconductor (NMOS) transistor connected to a second NMOS transistor at a junction.

In some embodiments, the junction is directly connected to the gate terminal.

In some embodiments, a transformer including a primary winding magnetically coupled to a secondary winding, the primary winding including a first terminal connected to an input voltage and a second terminal coupled to a ground via a primary switch, where the secondary winding includes a third terminal connected to an output terminal, and further includes a fourth terminal connected to a secondary switch, where the secondary switch includes a gate terminal, a source terminal and a drain terminal; a current sense device coupled to the secondary switch and arranged to generate a current signal corresponding to a current flowing through the secondary switch; a comparator having a first input connected to a predetermined current reference, a second input connected to the current sense device and a first output coupled to counter circuit; a counter having a third input coupled to the first output, and further having a second output; a digital-to-analog circuit having a fourth input coupled to the second output, and further having a third output connected to the gate terminal; where the comparator, the counter and the digital-to-analog circuit are arranged to receive the current signal from the current sense device and generate a corresponding gate voltage signal at the gate terminal to control a conductivity state of the secondary switch.

In some embodiments, the first output is coupled to the counter through a current mirror circuit.

In some embodiments, the current sense device includes a third switch coupled in parallel with the secondary switch.

In some embodiments, the current sense device includes a resistor coupled in parallel with the secondary switch.

In some embodiments, the circuit further includes a second comparator having a fifth input connected to a predetermined voltage, a sixth input connected to the drain terminal, and a fourth output connected to the gate terminal.

In some embodiments, the second comparator is arranged to turn off the secondary switch when a drain terminal voltage drops below the predetermined voltage.

### BRIEF DESCRIPTION OF THE DRAWINGS

FIG. 1 illustrates a control circuit with one comparator for the turn-off of the a secondary side synchronous rectifier (SR) switch, according to some embodiments;

FIG. 2 illustrates graphs of various operating voltages of the circuit of FIG. 1, acceding to some embodiments;

FIG. 3 illustrates a control circuit using two comparators for turn-off of the SR switch, according to some embodiments;

FIG. 4A illustrates a control circuit using two comparators and a sample and hold circuit for controlling conductivity state of the SR switch, according to some embodiments;

FIG. 4B illustrates graphs of various operating voltages of the circuit of FIG. 3, acceding to some embodiments;

FIGS. 4C and 4D illustrates variations of the circuit of FIG. 4A, according to some embodiments;

FIG. 5A shows an AHB converter with a secondary side SR control circuit, according to some embodiments;

FIG. 5B illustrates a circuit for generating a drive signal for a SR switch in FIG. 5A, according to some embodiments;

FIG. 5C illustrates operating graphs with the debounce blank circuit of control circuit in FIGS. 5A and 5B, according to some embodiments;

FIG. 6A illustrates a control circuit having a turn-off and a turn-on circuit for the SR switch, according to some embodiments;

FIGS. 6B and 6C illustrate graphs of various operating voltages of the circuit of FIG. 6A, acceding to some embodiments;

FIG. 7A illustrates a control circuit for SR switch turn-on and turn-off using a counter circuit, according to certain embodiments;

FIG. 7B illustrates operating voltages for circuit of FIG. 7A, according to certain embodiments;

FIG. 8 illustrates a control circuit for SR switch turn-on and turn-off using a counter and DAC circuit, according to various embodiments; and

FIG. 9 illustrates various operating voltages and currents of FIG. 8, according to various embodiments.

### DETAILED DESCRIPTION

Circuits, devices and related techniques disclosed herein relate generally to power converters. More specifically, systems, circuits, devices and related techniques disclosed herein relate to synchronous rectifier (SR) switch control circuits and methods of operating the control circuits. In some embodiments, a control circuit can include an amplifier, a first and second comparators, where the amplifier and the first and second comparators are arranged to receive a voltage signal from the drain terminal of the SR switch and generate a corresponding gate voltage signal at the gate terminal to control a conductivity state of the secondary switch. Circuits and techniques disclosed herein enable the use of two comparators with two predetermined thresholds to regulate a voltage of the drain terminal to within a reasonable range even if the amplifier may not function well. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

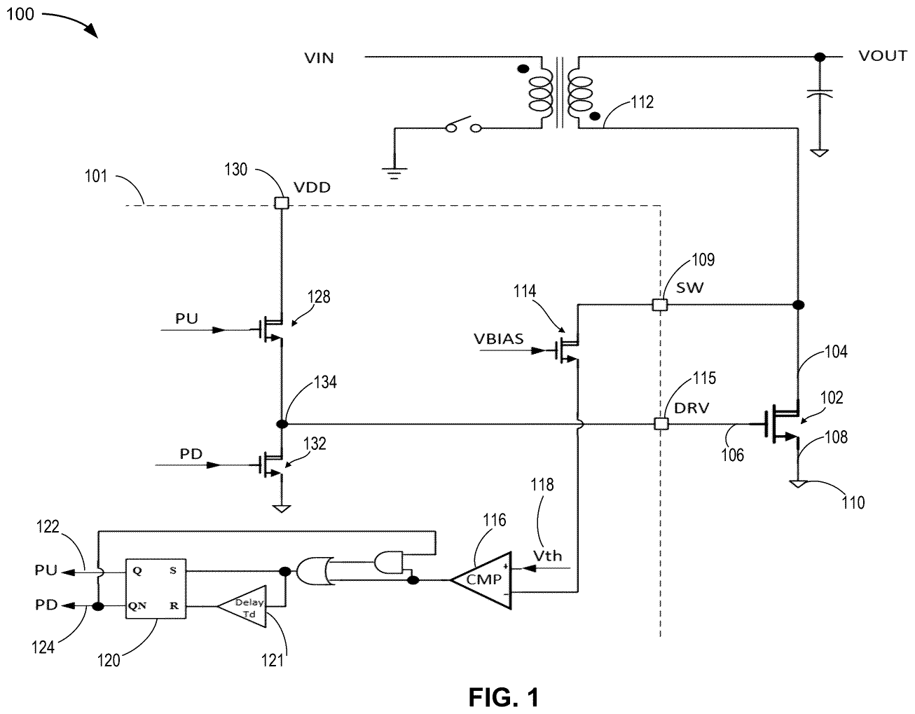

FIG. 1 illustrates a control circuit with one comparator for the turn-off of the SR switch, according to some embodiments. Circuit 100 illustrates a flyback converter having a control circuit 101 that is connected to a secondary side synchronous rectifier (SR) switch 102. The SR switch can have a drain terminal 104, a gate terminal 106 and a source terminal 108. The source terminal 108 can be connected to ground 110. The drain terminal 104 can be connected to a first terminal 112 of a secondary side winding. The drain terminal 104 can also be connected to an input pin 109 (labeled SW) of the control circuit 101. The SW pin can be connected to a bias switch 114. The bias switch 114 can be connected to a first input of a comparator 116. A second input of the comparator 116 can be connected to a threshold voltage 118. The comparator 116 can be connected to a SR latch 120. The SR latch can be arranged to generate a first signal PU at its output terminal 122 and a second output signal PL at its output terminal 124. The output terminal 122 can be connected to a gate terminal of a switch 128 and the output terminal 124 can be connected to a gate terminal of a switch 132. The switch 128 and 132 can be connected in series between a power supply VDD 130 and the ground 110. A source terminal of the switch 128 can be connected to a drain terminal of the switch 132 at a node 134. Node 134 can be connected to an output pin 115 (labeled DRV). The DRV pin can be connected to the gate terminal 106.

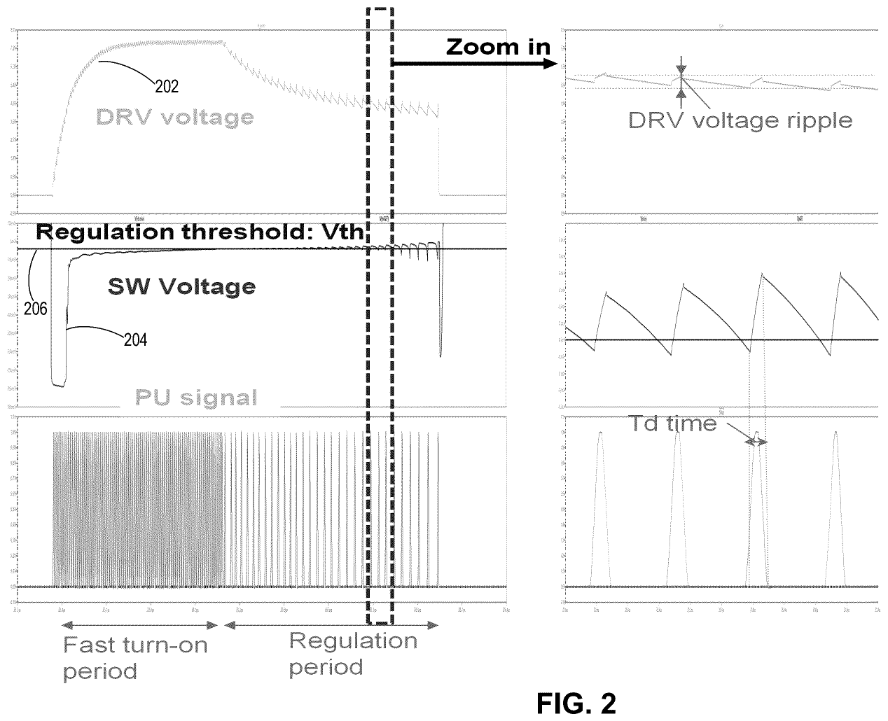

When the voltage at the SW pin drops below the threshold voltage 118, the comparator can turn on and cause the DRV voltage to go high such that the switch 102 turns on. FIG. 2 illustrates graphs of various voltages of the circuit 100. FIG. 2 shows SW voltage 204, the threshold voltage 206 and the drive (DRV) voltage 202. As can be seen, when SW voltage 204 drops below the threshold voltage 206, DRV voltage 202 goes high. The turn on of the DRV voltage can be relatively fast. When SW voltage rises to threshold voltage, the DRV voltage is regulated to maintain value of the threshold voltage on the SW pin. As soon as the SW voltage goes above 0, DRV is pulled to ground. When SW drops below the threshold voltage 118, the PU signal can turn on repetitively relatively rapidly causing the switch 128 to turn on and supply a current into the gate terminal 106. During the regulation period, the PU signal can turn on relatively slowly while the DRV voltage may be reduced. In some embodiments, Td (delay time of the delay circuit 121) can be modulated by the DRV voltage (e.g., Td∝1/VDRV) to decrease the DRV voltage ripple.

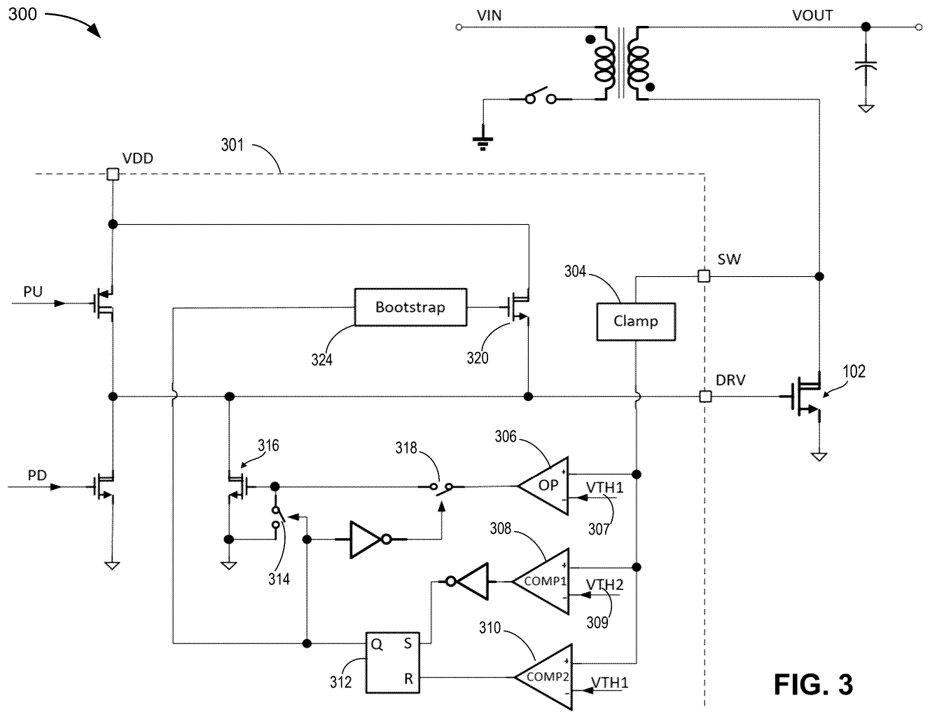

FIG. 3 illustrates a control circuit using two comparators for turn-off of the SR switch, according to some embodiments. Circuit 300 illustrates a flyback converter having a control circuit 301 that is connected to an SR switch 102. An SW pin of the control circuit 301 can be connected to a clamp circuit 304. The clamp circuit 304 can be connected to a first input terminal of an Opamp 306, to a first input terminal of a comparator 308 and to a first input terminal of a comparator 310. A second input of the Opamp 306 and a second input of the comparator 310 can be connected to a threshold voltage 307 (labeled Vth1). A second input of the comparator 308 can be connected to a threshold voltage 309 (labeled Vth2). An output of the Opamp 306 can be connected to a switch 318 that is connected to a gate terminal of a switch 316. An output of the comparator 308 and an output of the comparator 310 can be connected to a latch 312. The output of the latch 312 can be connected to a switch 314. Switch 314 can be connected to switch 316. The output of the latch 312 can also be connected to a bootstrap circuit 324 that is connected to a gate terminal of the switch 320. Switch 314 can be connected to switch 316. A drain terminal of switch 316 can be connected to the gate terminal 106 of the SR switch 102. A source terminal of the switch 320 can be connected to the gate terminal of the SR switch 102.

When a negative voltage is sensed at the SW pin that is less than Vth2, the DRV voltage can go high, and the conductive resistance of SR switch is reduced, and SW voltage goes high. When SW voltage rises to Vth1, the DRV voltage is regulated to maintain value of Vth1 on the SW pin. When SW voltage is above 0, DRV is pulled to ground. When a voltage at the SW (Vsw) pin is less than Vth2, comparator 310 turns on and sets the latch 312. The output of the latch (Q) 312 goes high and turns on switch 314, causing switch 316 to turn off. At the same time, to prevent contention, the switch 318. Thus, the output of Opamp 306 cannot not “fight” with switch 314 trying to control switch 316. Also, when Q is high, switch 320 is turned on to pull-up DRV. Further, no help from either comparator 308 or 310 is needed to assist Opamp 306. The Opamp 306 can operate on its own to regulate the gate voltage of the SR switch 102.

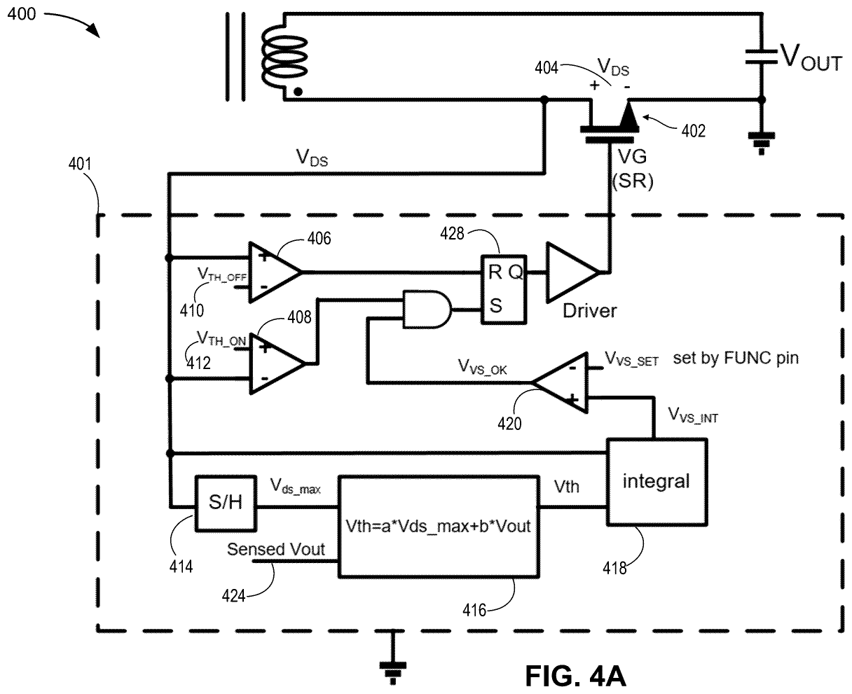

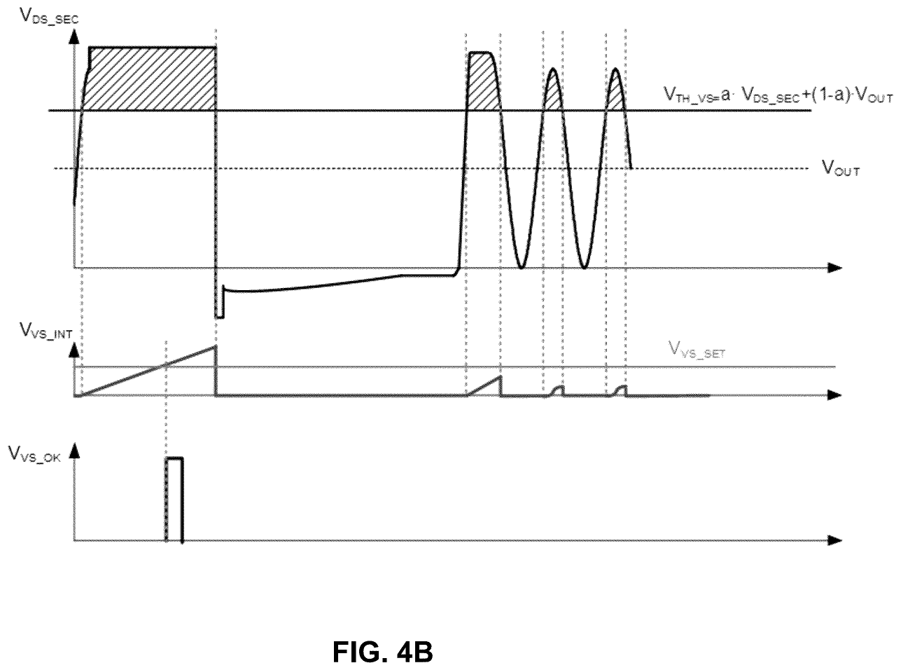

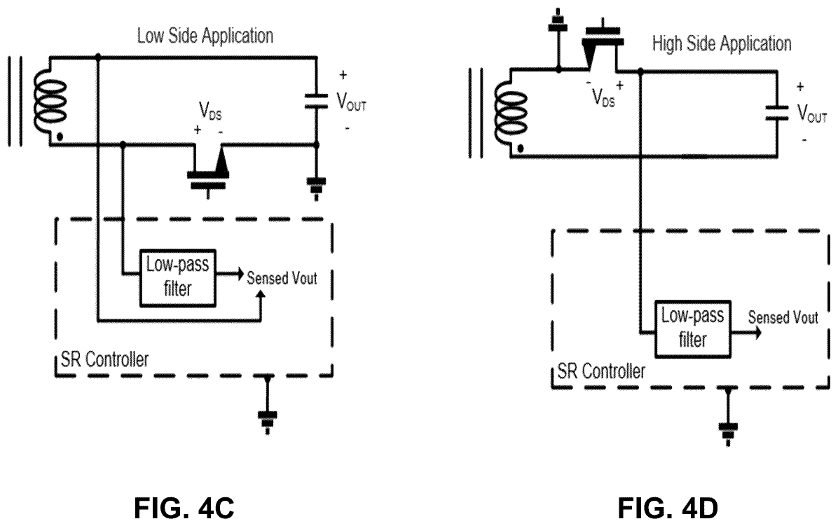

FIG. 4A illustrates a control circuit using two comparators and a sample and hold circuit for controlling turn on condition of the SR switch, according to some embodiments. During DCM ringing period, a low point of the valley (of the ringing) may go below the turn-on threshold voltage (VTH_ON) and may cause mis-turn-on of SR switch. Circuits and techniques disclosed herein are arranged to distinguish the primary-side switch on period and the DCM ringing period in order to prevent false turn on of the SR switch. Circuit 400 illustrates a secondary side of a flyback converter having a control circuit 401 that is connected to a SR switch 402 and is arranged to avoid mis-turn-on of the SR switch. The VDS voltage 404 of the SR switch is sensed by control circuit 401 and compared to VTH_ON to determine the SR switch turn-on timing.

Control circuit 401 can include a comparator 406, a comparator 408, a sample and hold circuit 414 that is coupled to a logic circuit 416, and an integral circuit 418 coupled to a comparator 420. An inverting input of the comparator 406 can be connected to a first predetermined threshold 410 (labeled Vth-off) and the non-inverting input of the comparator 408 can be connected to a second predetermined threshold 412 (labeled Vth-on).

Referring to FIGS. 4A, 4B, 4C and 4D, the control circuit 401 is arranged to sense a drain-source voltage 404 (VDS) of the SR switch 402. The VDS is compared to Vth-off and Vth-on by the comparators 406 and 408, respectively. The outputs of the comparators 406 and 408 are transmitted to a RS flip-flop 428 that is arranged to drive the gate terminal of the SR switch 402. The VDS is also sample and held, and a maximumVDS (Vdsmax) is generated that is transmitted to the logic circuit 416. An output of the flyback converter is also sensed and transmitted to the logic circuit 416 at the input 424. The logic circuit 416 can compare the sensed output to a predetermined threshold Vth having a value: Vth=a*Vds_max+b*Vout. The output of the logic circuit 416 is transmitted to the integral circuit 418. The output of the integral circuit 418 is compared, by the comparator 420, to a value VVS_SET that can be set using an external pin of the control circuit 401. The output of the comparator 420 is a signal VVS_OK that is fed into the Set input of the RS flip-flop 428.

In some embodiments, Vout can be sensed by low-pass filtering of the VDS or directly sense the output voltage in low-side application (shown in FIG. 4C). In various embodiments, Vout can be sensed by low-pass filtering of the VDS in high-side application (shown in FIG. 4D). The integral threshold Vth can be generated by: sample and hold the maximum value of drain-source voltage VDS of SR switch (Vds_max), sensed output voltage Vout, generate Vth=a*Vds_max+b*Vo. The integral area refers to the area between VDS and Vth (V_(VS_INT)=∫(V_DS−V_th)dt). The integral value V_(VS_INT) compared with set VS value (VVS_SET) to get the signal VVS OK for one of the SR FET turn-on necessary conditions. In some embodiments, there is a constraint on the value of a and b, such that a+b=1 and 0<a<1.

### SR Switch Control Circuit With Debounce Blanking

In current approaches in AHB converters, there can exist a reverse current that can flow when an SR controller recovers and is e turned on at n·Vout>Vcr condition. When the switches stop switching after a large transient like high load to light load, or high-Vo to low-Vo and the resonate capacitor is discharged by Rcr (n·Vout>Vcr*). The reverse current can cause mis-trigger and large voltage spikes can occur at the SR switch (In steady mode, n·Vout≈Vcr).

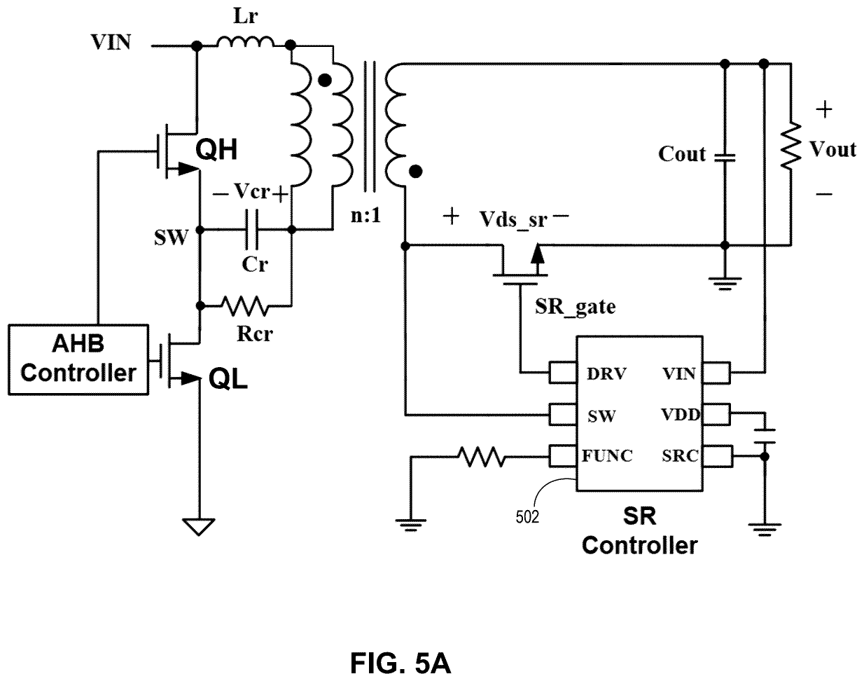

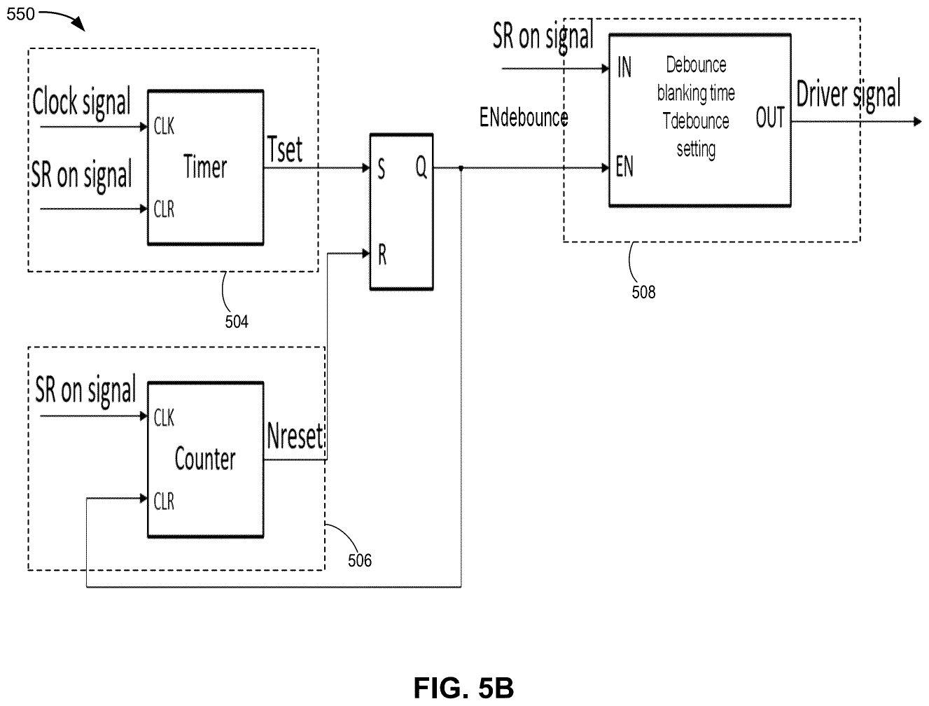

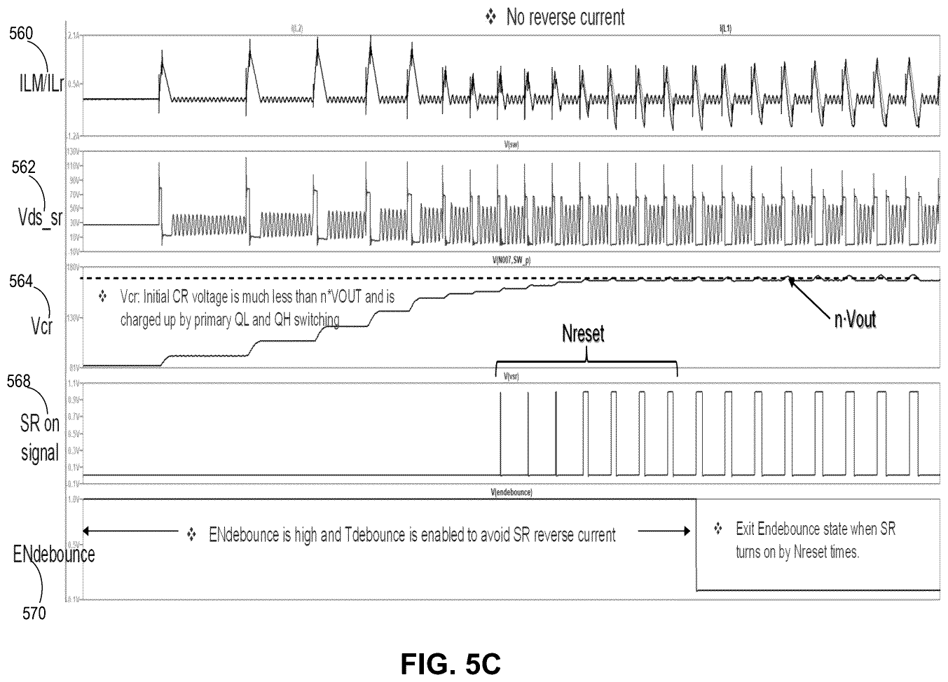

FIG. 5A shows an AHB converter with a secondary side SR control circuit, according to some embodiments. The SR control circuit 502 is arranged to provide a debounce blanking time for turn on signal for the SR switch. In some embodiments, in order to decrease conduction losses the SR control circuit 502 can exit debounce mode when SR switch turns on by a predetermined N times. In debounce mode, the SR control circuit 502 can add extra debounce blanking time (Tdebounce) for SR switch turn-on signal. SR switch can only be turned on by SR on-condition time being longer than Tdebounce.

FIG. 5B illustrates a circuit 550 for generating a drive signal for a SR switch, according to some embodiments. FIG. 5B includes a circuit 504 that is arranged for generating timing for Tset (to enter debounce mode). FIG. 5B also includes circuit 506 that is arranged to generate a signal Nreset (used for SR switch turned on by Nreset times to exit debounce mode). FIG. 5B further includes circuit 508 that is arranged to add extra debounce blanking time in debounce mode to avoid SR switch turn-on.

FIG. 5C illustrates operating graphs with the debounce blank circuit of control circuit 502 and 550. FIG. 5C shows operating graphs for current iLr (560), SR switch drain-source voltage (562), voltage across the resonant capacitor (Vcr) (564), SR switch gate voltage (568) and enable ENdebounce (570). The SR switch is in off state by Tdebounce time period and Vcr gets charged up by QL and QH switching. The SR switch is on when the Vcr voltage gets charged up to n*Vout for the SR on condition time is longer than Tdebounce, and no reverse current is observed for n·Vout≈Vcr. When SR is on, Tdebounce leads to longer body-diode on-time (higher conduction loss), the debounce mode needs to be disabled for Nreset SR on times. Thus, in debounce mode, adds extra debounce blanking time (Tdebounce) for SR on signal and SR FET can only be turned on by SR on condition time longer than Tdebounce. Debounce mode can be disabled by SR FET turn on Nreset cycles.

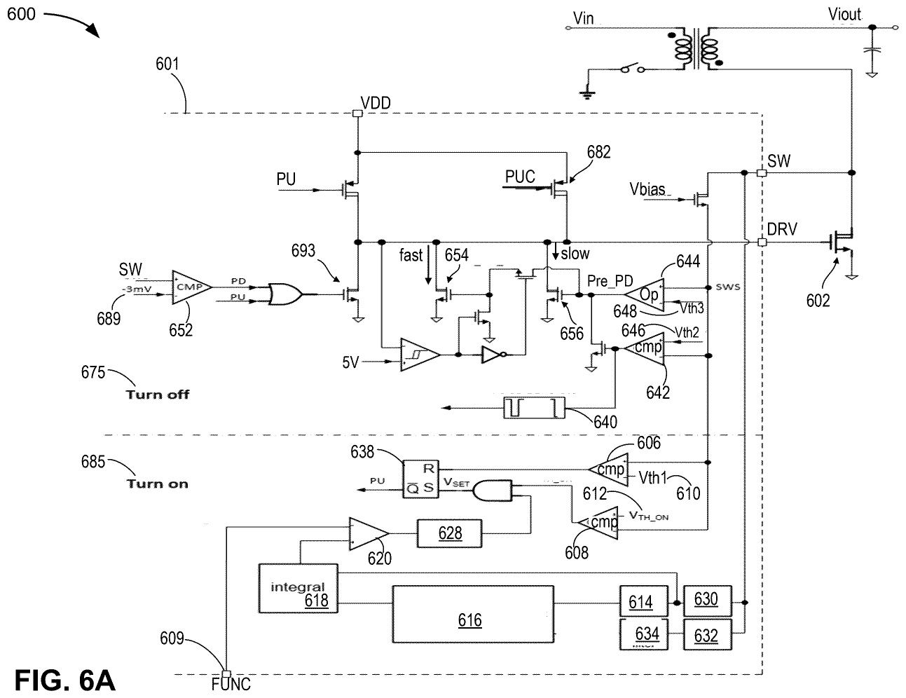

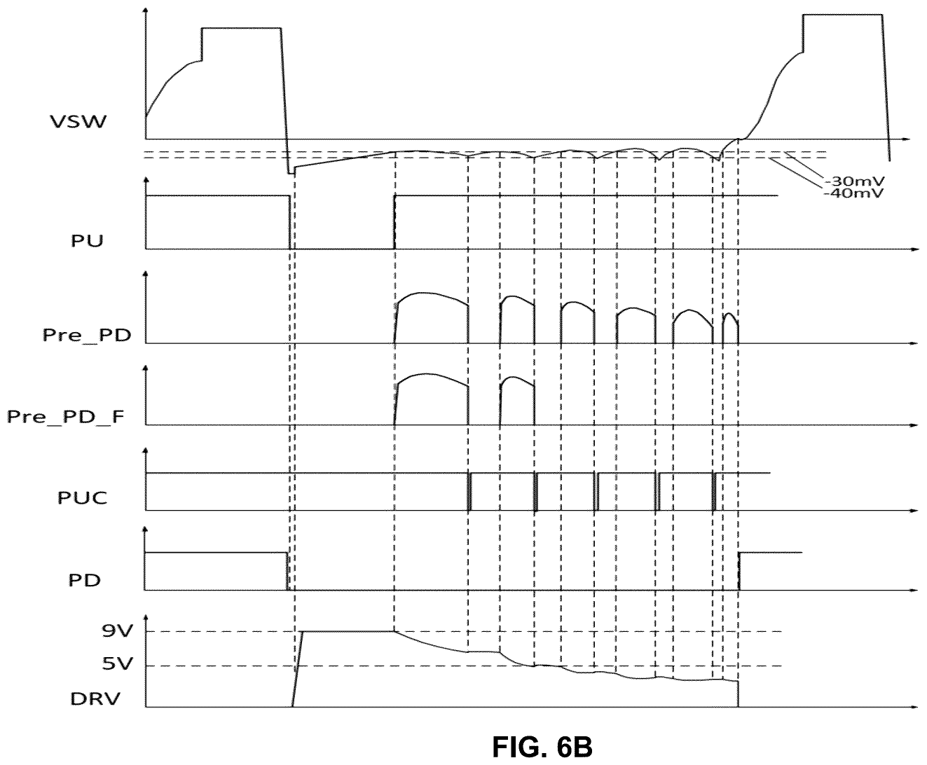

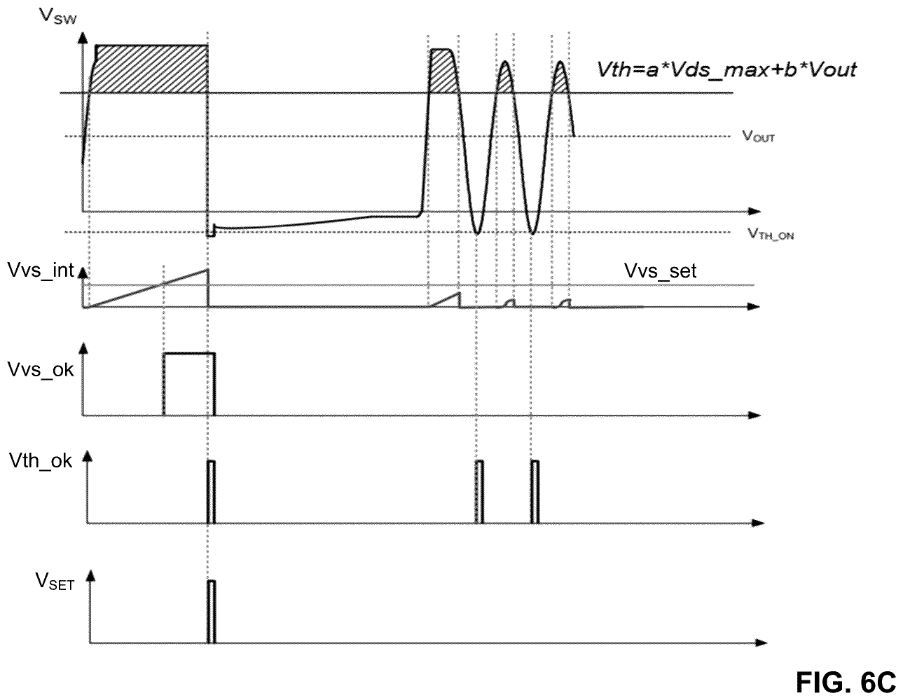

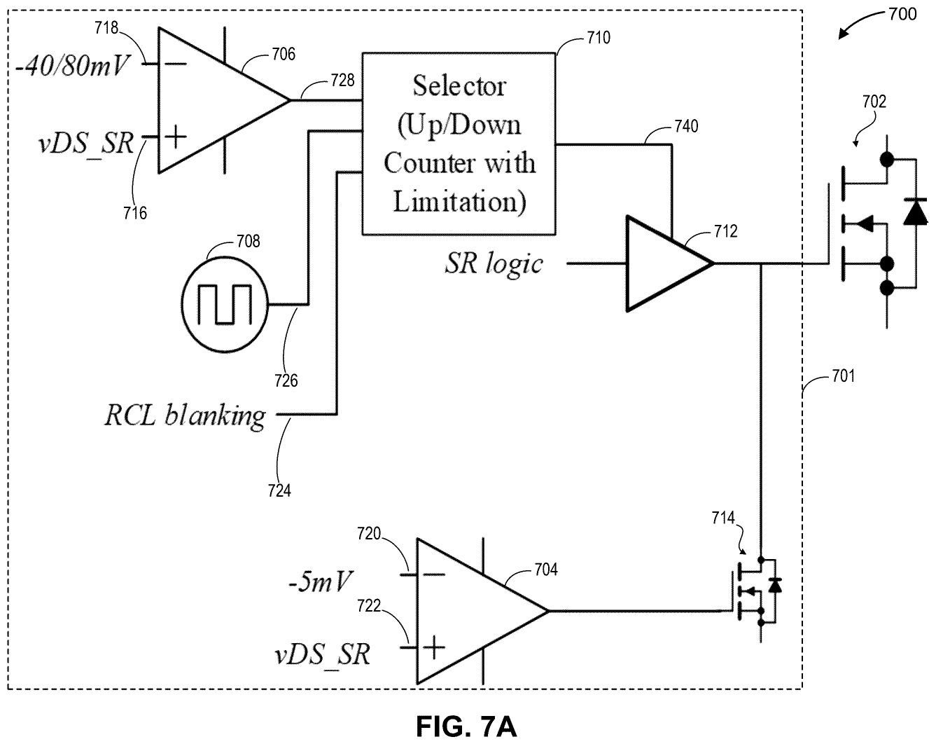

FIG. 6A illustrates a control circuit having a turn-off and a turn-on circuit for the SR switch, according to some embodiments. Circuit 600 illustrates a flyback converter having a control circuit 601 that is connected to an SR switch 602. The control circuit 601 can include a turn-off circuit 675 and a turn-on circuit 685. A drain terminal of the SR switch 602 can be connected to a SW pin of control circuit 601. A gate terminal of the SR switch 602 can be connected to a DRV pin of control circuit 601. The SW pin can be connected to an Opamp 644 and a comparator 642. An inverting input of the Opamp 644 can be connected to a threshold voltage 648 (labeled Vth3). In some embodiments, Vth3 can have a value of, for example, −30 mV. A non-inverting input of the comparator 642 can be connected to a threshold voltage 646 (labeled Vth2). In various embodiments, Vth2 can have a value of, for example, −40 mV. An output of the comparator 642 can be connected to a pulse generator circuit 640. The pulse generator circuit 640 can be arranged to generate a pulse labeled PUC. An output of the Opamp 644 can be connected to a gate terminal of the switch 656. The output of the Opamp 644 can also be connected to a gate terminal of the switch 654.

In the turn-on circuit 685, the SW pin can be connected to a comparator 606 and a comparator 608. An inverting input of the comparator 606 can be connected to a threshold voltage 610 (labeled Vth1). In some embodiments, Vth1 can have a value of, for example, −30 mV. A non-inverting input of the comparator 608 can be connected to a threshold voltage 612 (labeled Vth-on). An output of the comparator 606 can be connected to a Reset input of a latch 638. An output of the comparator 608 can be connected to a Set input of a latch 638. Latch 638 can be arranged to generate signal PU at its output. The SW pin can also be connected to gain circuit 630 and a gain circuit 632. An output of the gain circuit 630 can be connected to a sample and hold circuit 614. An output of the gain circuit 632 can be connected to a low pass filter 634. An output of the sample and hold circuit can be a voltage having a value Vds-max (maximum drain-source voltage of the SR switch). An output of the sample and hold circuit can be a sensed output voltage. The output of the sample and hold circuit 614, and the output of the low pass filter 634 can be transmitted to a logic circuit 616.

A voltage at the drain of the SR switch can be sensed and transmitted to the logic circuit 616. The logic circuit 616 can compare the sensed voltage to a predetermined threshold Vth having a value: Vth=a*Vds_max+b*Vout. The output of the logic circuit 416 is transmitted to the integral circuit 618. The output of the integral circuit 418 is compared, by the comparator 620, to a value VVS_SET that can be set using an external pin 609 (labeled FUNC) of the control circuit 601. The output of the comparator 620 can be transmitted to a RS flip-flop 628 that is arranged to generate a signal VVS OK that is fed into the Set input of the latch 638. In some embodiments, the latch 638 can be an RS flip-flop.

### Turn-Off

Now referring to FIGS. 6A and 6B, after VSW higher than −30 mV, Opamp 644 can start to turn on switch 654 (fast) and 656 (slow) to pull down the DRV pin. In some embodiments, DRV pin voltage can be pulled down relatively fast. When the voltage at the SW pin (VSW) is lower than −40 mV (after triggering the Opamp 644), the comparator 642 can turn off the switch 656 and 654. At the same time, the comparator 642 can cause the pulse generator circuit 640 to generate a pulse PUC. The output of the pulse generator 640 can be connected to a gate terminal of a switch 682. Pulse PUC can cause the switch 682 to turn on and pull up DRV pin. In various embodiments, the magnitude of this pull up may be relatively small. When a voltage at the DRV pin falls below 5 V, switch 654 may be kept in off state while keeping the switch 656 in an on state. In some embodiments, when VSW is higher than a “force turn off” threshold 689, comparator 652 can cause the DRV voltage to be pulled down through switch 693. In various embodiments, a value of the “force turn off” threshold 689 can be, for example, −3 mV.

### Turn-On

Now referring to FIGS. 6A and 6C, the sensed drain voltage of SR switch can be compared to the turn-on threshold VTH-ON, by the comparator 608, to generate the signal VTH_OK. The signal VTH_OK being high can be one necessary condition be for the turn-on of the SR switch. The integral circuit can generate a value VVS_INT that can be compared with set VS value (VVS_SET) to generate the signal VVS_OK for the other necessary condition for the turn-on of the SR switch. Once both of the two necessary conditions are met, the SR switch can be turned on. In this way, a false turn-on during DCM ringing can be prevented.

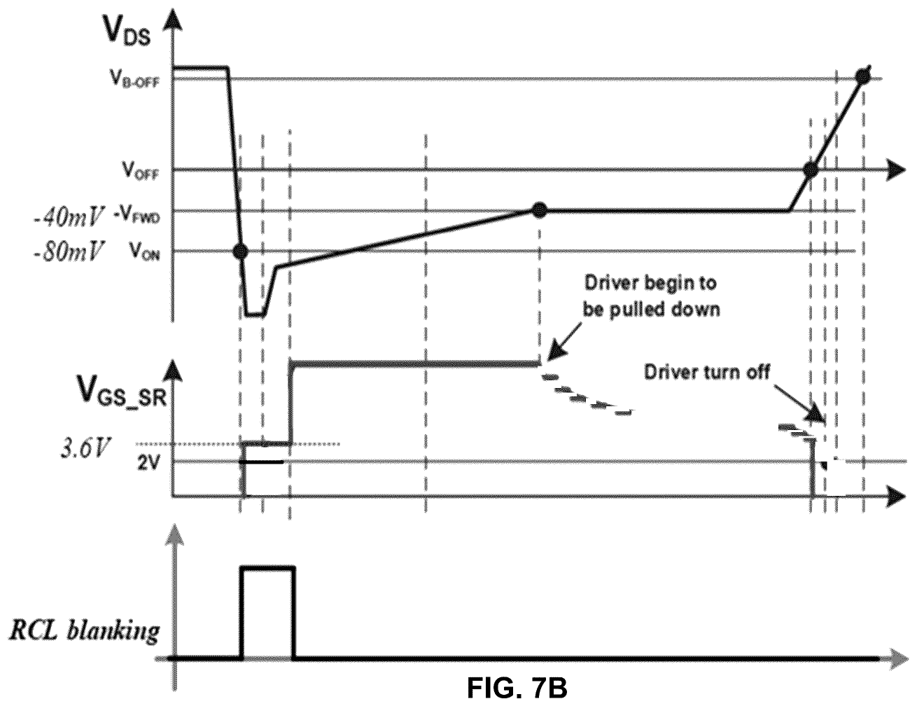

FIG. 7A illustrates a control circuit for SR switch turn-on and turn-off using a counter circuit, according to certain embodiments. FIG. 7A shows a circuit 700 having a control circuit 701 that is connected to an SR switch 702. The control circuit 701 can include a comparator 706 having an inverting input 718 and a non-inverting input 716. The non-inverting input 716 can be connected to a drain terminal of the SR switch 702 and the inverting input 718 can be connected to a DC threshold voltage. In some embodiments, the DC threshold voltage can be, for example, −40 mV, while in other embodiments the DC threshold voltage can be, for example, −80 mV. In various embodiments, the DC threshold voltage can be switched between a first value and a second value, for example, −40 mV and −80 mV. In the illustrated embodiment, different threshold voltages can be interchanged within a switching period. In this embodiment, referring to FIG. 7B, Vth=−80 mV when RCL blanking=1; Vth=−40 V when RCL blanking=0. The purpose is to determine a short period (RCL) in a relatively high Z in case of SR mis-trigger in an AHB system. During this period, the gate drive can stay at 3.6V. If SR switch mis-triggers and shoot-through occurs, the relatively high Z stage can protect the system and turn-off SR right away.

The comparator 706 can have an output terminal 728 that is connected to a selector circuit 710. In some embodiments, the selector circuit can include an up/down counter. The selector circuit can include an input terminal 726 that is connected to a clock circuit 708. The selector circuit can further include an input terminal 724 that is connected to a blanking circuit (labeled RCL blanking). The selector circuit 710 can have an output terminal 740 that can be connected to a driver 712. The control circuit 701 can further include a comparator 704 having an inverting terminal 720 and a non-inverting terminal 722. The inverting terminal 720 can be connected to a DC value, for example, −5 mV. The non-inverting terminal 722 can be connected to the drain terminal of the SR switch 702. The output of the comparator 704 can be connected to a switch 714 that is arranged to pull down the gate terminal of the SR switch 702.

FIG. 7B illustrates operating voltages for circuit 700. FIG. 7B shows the drain-source voltage (VDS) of the SR switch 702, the gate voltage (VGS) of the SR switch 702 and RCL blanking pulse. Now referring to FIGS. 7A and 7B, the operation of circuit 700 is described. Comparator 706 can detect VDS of the SR switch and compare it with a de voltage. In some embodiments, the DC voltage can be fixed while in alternate embodiments it can be switching. The comparator 706 can provide an input to the selector circuit 710. The selector circuit 710 can count up/down or be set to a certain count value based on the output of the comparator 706. The output of the selector/counter 710 can change the gate voltage of the SR switch.

In some embodiments, the output of the selector/counter 710 can be directly connected to the SR switch gate terminal. In various embodiments, the output of the selector/counter 710 can be indirectly connected to the SR switch gate terminal. In some embodiments, the control circuit 701 can be arranged to have a limit on its maximumVGS voltage level, prior to the SR switching signal starting. In various embodiments, the control circuit 701 can be arranged to change the gate drive on the gate terminal of the SR switch prior to the SR switching signal starting. In some embodiments, the control circuit 701 can detect a current flowing through the SR switch 702 and generate a gate drive correspondingly.

During RCL blanking, the selector circuit 710 will track the up-down counter to look for Vds in the first target value, for example, −80 mV. In some embodiments, the selector circuit 710 can include a DAC in addition to the counter. During RCL blanking, a maximum DAC output can be, for example, 3.6V. When VDS is less than −80 mV, the DAC output will be set at maximum DAC output value, i.e., 3.6V. After the blanking time period RCL, the selector circuit 710 will track the up-down counter to look for Vds in the second target value, for example, −40 mV. And the maximum DAC output can be, for example, 9V. When VDS is less than −40 mV, the DAC output will be set at maximum DAC output value, i.e., 9V. When VDS reaches Vth-off, the SR switch may turn off immediately. In some embodiments, clock generation circuit 708 can generate a clock signal (CLK) having a time period of, for example, 20 to 50 ns. In various embodiments, the DAC output may be 9 V, 8 V, 7 V, 6 V, 5 V, 4 V (6 steps, 1 V each). 4 V, 3.8V, 3.6 V, . . . 2 V (10 steps, 0.2V each), for a total of 16 steps.

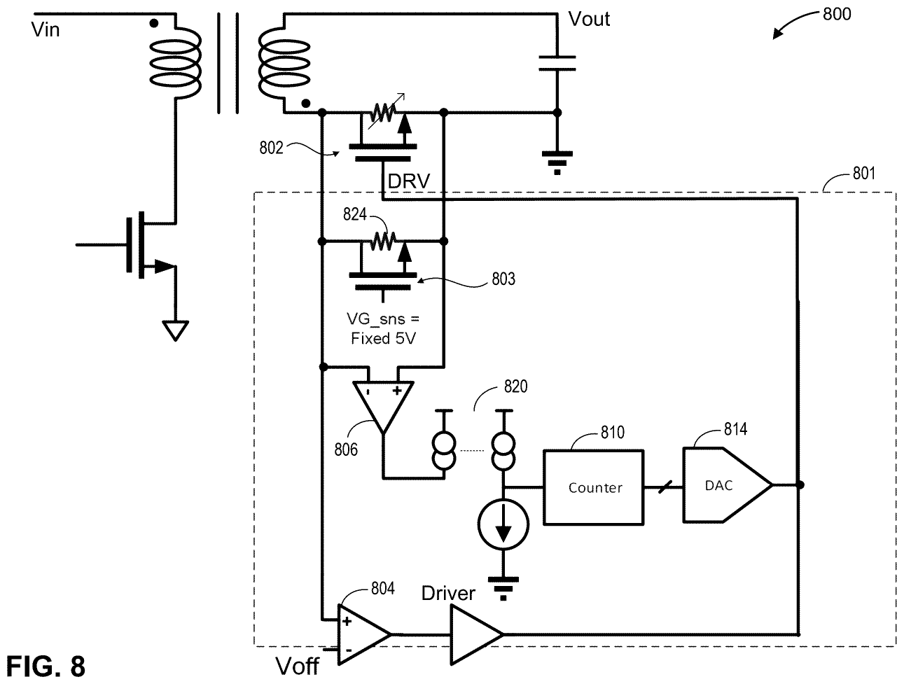

FIG. 8 illustrates a control circuit for SR switch turn-on and turn-off using a counter and DAC circuit, according to various embodiments. FIG. 8 shows a circuit 800 having a control circuit 801 that is connected to an SR switch 802 that is on the secondary side of a flyback converter. The control circuit 801 can include an Opamp 806 that is connected to the drain and source terminals of the SR switch. In some embodiments, the Opamp 806 can be arranged to generate a current on its output terminal. The Opamp 806 can have an output terminal that is connected to a current mirror 820. The current mirror can be connected to a counter 810 that is connected to a digital to analog converter (DAC). The output of the DAC can be connected to the gate terminal of the SR switch.

The control circuit 801 can further include a comparator 804. An inverting terminal of the comparator 804 can be connected to the drain terminal of the SR switch and a non-inverting terminal of the comparator 804 can be connected to a DC value (labeled Voff). The output of the comparator 804 can be connected to the gate terminal of the SR switch, where the comparator 804 can be arranged to turn-off the SR switch 802 when the comparator 804 detects a SR switch drain voltage that is higher than Voff. The control circuit 801 can further include a switch 803 that is coupled to the drain and source terminals of the SR switch 802. The control circuit 801 can additionally include a switch resistor 824 that is coupled across the drain to source terminals of the SR switch 802. In some embodiments, switch 803 and resistor 824 can be arranged to sense the current flowing through the SR switch 802.

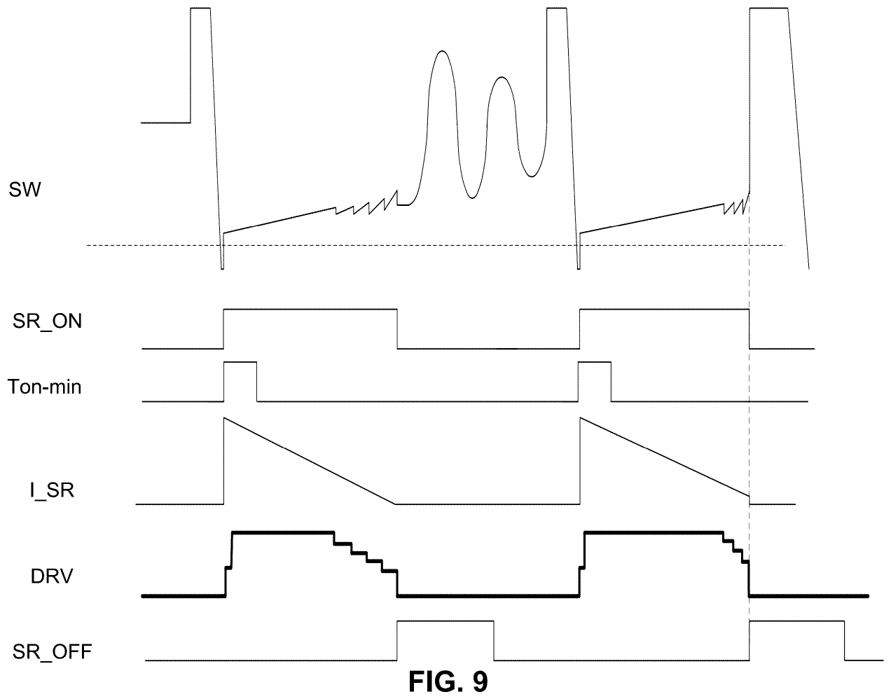

In the illustrated embodiment, a current sensing circuit can be used to detect a current flowing through the SR switch 802. FIG. 9 shows various operating voltages and currents of the circuit 800. Referring to FIGS. 8 and 9, the current sensing circuit can be connected to a comparator where the other input of the comparator can be connected to a pre-determined reference voltage. In some embodiments, a pre-determined reference current can be used for the comparator. For SR switch tum-on transient, when SR switch current reaches the pre-determined reference before Ton-min, the counter 810 can count up and increase VDAC (DRV). The counter 810 and DAC 814 outputs are arranged for a DRV pre-bias such that any mis-triggered of SR switch can be detected, so that the SR switch can be turned off relatively fast. For SR switch turn-off transient, when SR current reaches the pre-determined reference after Ton-min, the counter counts down and reduces VDAC (DRV). The counter and DAC outputs are arranged to scale the DRV and minimize the error term of current sensing with a step-down Vgs (SR_DRV). In some embodiments, the DAC resolution for turn-on can have a different value than the turn-off. For example, turn-on can have 1-bit (2 step) resolution, while turn-off may have 5-bit (32 steps) resolution.

In some embodiments, combination of the circuits and methods disclosed herein can be utilized to provide secondary side synchronous rectifier control circuits and methods of operating the control circuits. Although circuits and methods are described and illustrated herein with respect to several particular configuration of flyback converters, embodiments of the disclosure are suitable for operating other power converter circuits such as, but not limited to, AHB and ACF.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,”an example,“certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a transformer including a primary winding magnetically coupled to a secondary winding, the primary winding including a first terminal connected to an input voltage and a second terminal coupled to a ground via a primary switch, wherein the secondary winding includes a third terminal connected to an output terminal, and further includes a fourth terminal connected to a secondary switch, wherein the secondary switch includes a gate terminal, a source terminal and a drain terminal;
an amplifier having a first input coupled to a first predetermined voltage, a second input coupled to the drain terminal, and a first output connected to the gate terminal; and
a first comparator having a third input connected to the first predetermined voltage, a fourth input connected to the drain terminal, and a second output coupled to the gate terminal; and
a second comparator having a fifth input connected to a second predetermined voltage, a sixth input connected to the drain terminal, and a third output connected to the gate terminal; and
wherein the amplifier and the first and second comparators are arranged to receive a voltage signal from the drain terminal and generate a corresponding gate voltage signal at the gate terminal to control a conductivity state of the secondary switch.

2. The circuit of claim 1, wherein the first output is connected to the gate terminal through a pull-down switch that is connected to the gate terminal.

3. The circuit of claim 2, wherein the second output is connected to the gate terminal through a set-reset latch that is connected to the pull-down switch.

4. The circuit of claim 3, wherein the third output is connected to the gate terminal through the set-reset latch.

5. The circuit of claim 1, wherein the first predetermined voltage has a value that is different than the second predetermined voltage.

6. The circuit of claim 1, wherein when a drain terminal voltage goes below the second predetermined voltage, the amplifier and the first and second comparators are arranged to regulate the drain terminal voltage such that it remains between the first and second predetermined voltages.

7. The circuit of claim 1, wherein when a drain terminal voltage goes below the second predetermined voltage, the gate voltage signal at the gate terminal is increased at a first rate of voltage with respect to time from a first voltage to a first intermediate voltage, and at a second rate of voltage with respect to time from the first intermediate voltage to a second voltage.

8. The circuit of claim 7, wherein the first voltage is zero.

9. The circuit of claim 1, further comprising a third comparator having a seventh input connected to a third predetermined voltage, an eight input connected to the drain terminal, and a fourth output connected to the gate terminal.

10. The circuit of claim 9, wherein the third predetermined voltage is smaller than the first predetermined voltage and wherein the third comparator is arranged to turn off the secondary switch when a drain terminal voltage drops below the third predetermined voltage.

11. A circuit comprising:
a transformer including a primary winding magnetically coupled to a secondary winding, the primary winding including a first terminal connected to an input voltage and a second terminal coupled to a ground via a primary switch, wherein the secondary winding includes a third terminal connected to an output terminal, and further includes a fourth terminal connected to a secondary switch, wherein the secondary switch includes a gate terminal, a source terminal and a drain terminal; and
a comparator having a first input connected to a predetermined voltage, a second input connected to the drain terminal, and an output coupled to a half-bridge circuit; and
wherein the comparator and the half-bridge circuit are arranged to receive a voltage signal from the drain terminal and generate a corresponding gate voltage signal at the gate terminal to control a conductivity state of the secondary switch.

12. The circuit of claim 11, wherein the output is coupled to the half-bridge circuit via an RS flip-flop.

13. The circuit of claim 11, wherein the half-bridge circuit comprises a first N-channel metal oxide semiconductor (NMOS) transistor connected to a second NMOS transistor at a junction.

14. The circuit of claim 13, wherein the junction is directly connected to the gate terminal.

15. A circuit comprising:
a transformer including a primary winding magnetically coupled to a secondary winding, the primary winding including a first terminal connected to an input voltage and a second terminal coupled to a ground via a primary switch, wherein the secondary winding includes a third terminal connected to an output terminal, and further includes a fourth terminal connected to a secondary switch, wherein the secondary switch includes a gate terminal, a source terminal and a drain terminal;
a current sense device coupled to the secondary switch and arranged to generate a current signal corresponding to a current flowing through the secondary switch;
a comparator having a first input connected to a predetermined current reference, a second input connected to the current sense device and a first output coupled to counter circuit;
a counter having a third input coupled to the first output, and further having a second output;
a digital-to-analog circuit having a fourth input coupled to the second output, and further having a third output connected to the gate terminal; and
wherein the comparator, the counter and the digital-to-analog circuit are arranged to receive the current signal from the current sense device and generate a corresponding gate voltage signal at the gate terminal to control a conductivity state of the secondary switch.

16. The circuit of claim 15, wherein the first output is coupled to the counter through a current mirror circuit.

17. The circuit of claim 15, wherein the current sense device comprises a third switch coupled in parallel with the secondary switch.

18. The circuit of claim 15, wherein the current sense device comprises a resistor coupled in parallel with the secondary switch.

19. The circuit of claim 15, further comprising a second comparator having a fifth input connected to a predetermined voltage, a sixth input connected to the drain terminal, and a fourth output connected to the gate terminal.

20. The circuit of claim 19, wherein the second comparator is arranged to turn off the secondary switch when a drain terminal voltage drops below the predetermined voltage.
